(19) United States
(12) Patent Application Publication
(10) Pub. No.: US 2009/0217894 A1
(43) Pub. Date: Sep. 3, 2009

(54) METHOD OF BRAKING AN ACTUATOR PISTON, AND A PNEUMATIC ACTUATOR

(76) Inventors: Mats Hedman, Eskilstuna (SE); Anders Hoglund, Vejbystrand (SE)

Correspondence Address: KEVIN FARRELL;PIERCE ATWOOD, ONE NEW HAMPSHIRE AVENUE, PORTSMOUTH, NH, 03801, US

(21) Appl. No.: 12/162,991

(22) PCT Filed: Feb. 6, 2007
(86) PCT No.: PCT/SE2007/050074

§ 371 Date: Dec. 12, 2008

(30) Foreign Application Priority Data
Feb. 14, 2006 (SE) 0600320-6

(51) Int. Cl. F01L 9/02; F15B 9/10

(52) U.S. Cl. 123/90.14; 91/368

(57) ABSTRACT

A pneumatic actuator, connected to a pressure fluid circuit (6) that has a high pressure side and a low pressure side, an actuator cylinder (8, 9), an actuator piston (10, 11) provided in said actuator cylinder (8, 9) and displaceable between a first position and a second position, an actuator chamber (12, 13), delimited by said actuator cylinder (8, 9) and the actuator piston (10, 11), wherein the volume of said actuator chamber decreases upon a displacement of the actuator piston (10, 11) from the second to the first position to the first position, a spring means provided to drive the actuator piston (10, 11) from the second position to the first position, and means (25) provided to maintain or establish a communication between the low pressure side and the actuator chamber (12, 13), during a displacement of the actuator piston (10, 11) from the second position towards the first position, and at the same time to keep the communication between the high pressure side and the actuator chamber (12, 13) interrupted. The pneumatic actuator comprises means (25) provided to interrupt said communication between the low pressure side and the actuator chamber (12, 13) before the actuator piston (10, 11) reaches the first position.

### TECHNICAL FIELD

The present invention relates to a method of braking an actuator piston of a pneumatic actuator connected to a pressure fluid circuit that comprises a high pressure side and a low pressure side, and that comprises an actuator cylinder, an actuator piston provided in said actuator cylinder and displaceable between a first position and a second position, an actuator chamber delimited by said actuator cylinder and said actuator piston, wherein the volume of said actuator chamber decreases upon a displacement of the actuator piston from the second to the first position, and a spring means provided so as to drive the actuator piston from the second position to the first position, wherein, during a displacement of the actuator piston from the second position towards the first position, there is established or maintained a communication between the low pressure side and the actuator chamber, while, at the same time, the communication between the high pressure side and the actuator chamber is kept interrupted.

The invention also relates to a pneumatic actuator connected to a pressure fluid circuit that has a high pressure side and a low pressure side, and comprising an actuator cylinder, an actuator piston provided in said actuator cylinder and displaceable between a first position and a second position, an actuator chamber, delimited by said actuator cylinder and the actuator piston, wherein the volume of said actuator chamber decreases upon a displacement of the actuator piston from the second to the first position, a spring means provided to drive the actuator piston from the second position to the first position, and means provided to maintain or establish a communication between the low pressure side and the actuator chamber during a displacement of the actuator piston from the second position towards the first position, and at the same time to keep the communication between the high pressure side and the actuator chamber interrupted.

The invention also relates to a combustion engine, by which at least one engine valve is driven by a pneumatic actuator according to the invention.

The pressure fluid in the pressure fluid circuit is, preferably, a gas or a gas mixture, for example air.

The spring means may be a mechanical, a hydraulic or a pneumatic spring. It may be provided in direct or indirect contact with the actuator piston.

It is possible that the communication between the low pressure side and the actuator chamber is established already before the actuator piston reaches the second position during the preceding motion from the first position to the second position, and, in such a case, the communication is rather regarded as maintained than established during the motion from the second to the first position. Alternatively, said communication is established in connection to, or preferably, immediately after the second position having been reached and when the actuator piston is to be permitted to return to the first position.

### THE BACKGROUND OF THE INVENTION

Pressure fluid operated valves of combustion engines are already known, for example through several previous patent applications of the applicant. Such combustion engines comprise at least one cylinder and a piston that is reciprocatingly arranged in said cylinder, and a combustion chamber delimited by said cylinder and said piston, and at least one inlet for the introduction of combustion air to the combustion chamber, and at least one outlet for the discharge of exhaust gases from the combustion chamber, wherein at least one of said inlet or outlet is provided with at least one freely operable valve driven by means of pressurized fluid. Said valve is driven by a pneumatic actuator of the type initially described.

Typically, the pressure fluid-operated engine valve is a valve that, in its closed position, rests against a seat in a cylinder head and that, in order to be opened, is displaced into the combustion chamber, normally against the action of a valve spring. In connection to the opening motion, energy will be absorbed by the valve spring. When the valve is to be opened, the high pressure side of the pneumatic actuator will normally be brought into communication with the actuator chamber thereof for the purpose of generating an elevated pressure in the latter. Thereby, the actuator piston is displaced from a first position to a second position, while the engine valve to which the actuator piston is associated, is displaced from its closed position to its opened position.

Subsequently, when the pressure fluid-operated engine valve is to return to its closed position, the communication between the high pressure side of the pneumatic actuator and the actuator chamber is interrupted or kept interrupted, and a communication between its low pressure side and the actuator chamber is established. The energy of the pre-strained spring will thereby be used for the returning of the engine valve to the closed position, and a simultaneous return of the actuator piston to its first position, or start position.

The opening and the closure of the valve is rapid, and, accordingly, the valve will have a high top speed when moving between its opened and closed positions. A problem might be that the valve will hit the seat with a speed so high that the valve and/or the seat will run the risk of being damaged or obtaining a reduced function as a result thereof. Therefore, any kind of braking of the valve motion is desired, suitably by means of a method of braking the actuator piston of the pneumatic actuator and by means of a construction of the pneumatic actuator adapted to this method.

### THE OBJECT OF THE INVENTION

It is an object of the present invention to suggest a method for the braking of the actuator piston of a pneumatic actuator of the kind initially defined, wherein said method results in a soft landing of a valve driven by the pneumatic actuator in the seat of said valve in connection with the closure of said valve.

### SUMMARY OF THE INVENTION

The object of the invention is achieved by the initially defined method, which is characterized in that, before the actuator piston reaches the first position, said communication between the low pressure side and the actuator chamber is interrupted. Thereby, during the continued motion of the actuator piston towards the first position, there will be an increase of the pressure in the actuator chamber. The increase of the pressure will lead to a braking of the motion of the actuator piston, and, accordingly, a braking of the motion of an engine valve associated to said actuator piston.

According to a preferred embodiment of the invention, the communication between the low pressure side and the actuator chamber is interrupted when a continued reduction of the volume of said actuator chamber up to the point when the actuator piston reaches the first position is of such a magnitude that the increase of pressure that is generated in the actuator chamber upon the continued motion of the piston is sufficient to substantially reduce the speed of the actuator piston before the actuator piston reaches the first position.

Preferably, the communication between the low pressure side and the actuator chamber is interrupted when a continued reduction of the volume of the actuator chamber up to the point when the actuator piston reaches the first position is of such a magnitude that the increase of pressure that is generated in the actuator chamber upon the continued motion of the piston is sufficient to reduce the speed of the actuator piston to zero before the actuator piston reaches the first position.

In order to enable the fastest possible displacement of the actuator piston from the second position to the first position, and a corresponding displacement of an engine valve associated to said actuator piston from its open to its closed position, it is preferred that the braking be initiated as late as possible. Thereby, preferably, the communication between the low pressure side and the actuator chamber is interrupted after half the travelling distance of the actuator piston between the second and the first positions, preferably after a third of said travelling distance, and even more preferably, after a quarter of said travelling distance.

It is fully possible that the increase of the pressure in the actuator chamber during the braking will be of such magnitude that it will exceed the pressure that exists on the high pressure side. In order to provide for a recycling of energy, the invention therefore includes that, when the communication between the low pressure side and the actuator chamber has been interrupted, a communication between the high pressure side and the actuator chamber be established if the pressure in the actuator chamber exceeds the pressure on the high pressure side. It is also conceivable that the communication between the high pressure side and the actuator chamber be established even though the pressure in the actuator chamber is lower than the one on the high pressure side. Thereby, a more rapid increase of the pressure in the actuator chamber is accomplished, and the braking may be initiated at a later stage.

In order to guarantee that the actuator piston will reach its first position, the communication between the low pressure side and the actuator chamber should, according to the invention, be re-established when the motion of the actuator piston stops or is near to stop before the actuator piston reaches the first position.

It is preferred that the communication between the low pressure side and the actuator chamber is re-established generally at the moment when the motion of the actuator piston towards the first position stops. Thereby, a return bounce of the actuator piston in a direction towards the second position before having reached the first position is avoided. A softest possible braking is desirable, and will be achieved by the suggested method. Preferably, the braking, i.e. the choice of the timing of the interruption of the communication between the low pressure side and the actuator chamber, should be set at such a late stage that the motion of the actuator piston will cease as close to the first position as possible, or at least in the very neighbourhood of said first position.

If, during the braking, there has been established a communication between the high pressure side and the actuator chamber, this communication is interrupted in connection to, preferably simultaneously with, the re-establishment of the communication between the low pressure side and the actuator chamber.

The object of the invention is also achieved by means of the initially defined pneumatic actuator, which is characterized in that it comprises means arranged so as to interrupt said communication between the low pressure side and the actuator chamber before the actuator piston reaches the first position.

Furthermore, the pneumatic actuator preferably comprises means provided so as to interrupt the communication between the low pressure side and the actuator chamber when the actuator piston has reached a predetermined position while travelling from the second position towards the first position, and means provided so as to reestablish the communication between the low pressure side and the actuator chamber upon predetermined conditions. Said predetermined condition may be a position corresponding to a predetermined period of time for the motion of the actuator piston from the second position to the first position.

Preferably, the pneumatic actuator also comprises means provided to establish a communication between the high pressure side and the actuator chamber after the interruption of the communication between the low pressure side and the actuator chamber, if the pressure in the actuator chamber exceeds the pressure on the high pressure side. Such a means may comprise a non-return valve, provided so as to open in a direction towards the high pressure side and to close in a direction towards the actuator chamber. Such a non-return valve is then, suitably, provided in a branch of, or a channel parallel to the channel that extends between the high pressure side and the actuator chamber.

Preferably, said means comprise one or more sensors for sensing the motion and/or the position of the actuator chamber in the actuator cylinder, and/or noise or vibrations from the engine valve generated during the landing of the latter in its seat, and means arranged to control the establishment and interruption respectively of the communication between the high pressure side and the actuator chamber and between the low pressure side and the actuator chamber upon basis on signals from said sensors, wherein those latter means preferably comprise at least one electrically, preferably electromagnetically, operated valve member.

The invention also relates to a combustion engine comprising at least one cylinder and a piston performing a reciprocating motion therein, and a combustion chamber delimited by said cylinder and said piston, and at least one inlet for the introduction of combustion air to the combustion chamber, and at least one outlet for the discharge of exhaust gases from the combustion chamber, wherein at least one of said inlet and outlet is provided with at least one freely operable, pressure fluid-operated valve, characterized in that it comprises a pneumatic actuator according to the invention for the operation of said at least one valve.

Further features and advantages of the present invention will be disclosed in the following, detailed description and by the annexed patent claims.

### BRIEF DESCRIPTION OF THE DRAWINGS

Hereinafter, the invention will, by way of example, be described with reference to the annexed drawing, on which:

FIG. 1 is a schematic representation of a part of a combustion engine according to the invention,

FIG. 2 is a partly cut, schematic side view of a part of a pneumatic actuator according to a first embodiment,

FIG. 3 is a partly cut, schematic side view of a part of a pneumatic actuator according to a second embodiment,

FIG. 4 is a partly cut, schematic side view of a part of a pneumatic actuator according to a third embodiment,

FIG. 5 is a partly cut, schematic side view of a part of a pneumatic actuator according to a fourth embodiment,

FIG. 6 is a representation of a time schedule for the steps of an embodiment of the inventive method, and

FIG. 7 is a representation of a time schedule for the steps of a second embodiment of inventive method.

### DETAILED DESCRIPTION OF THE INVENTION

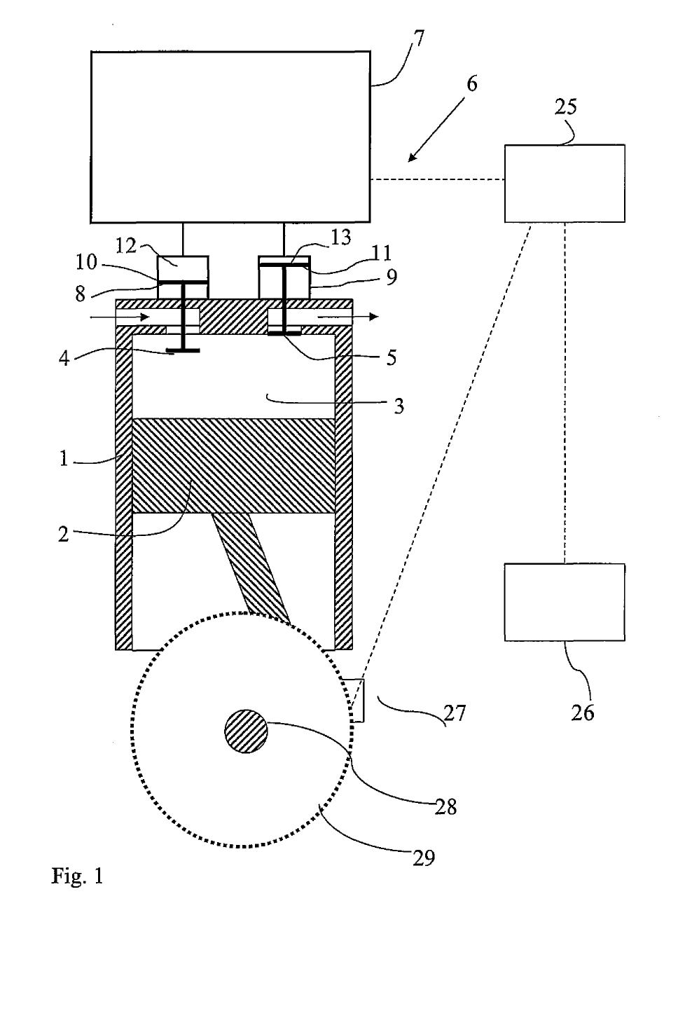

FIG. 1 schematically shows a part of a combustion engine according to the invention. The combustion engine comprises a cylinder 1, a piston 2 that is reciprocatingly arranged in said cylinder, a combustion chamber 3, delimited by said cylinder and said piston, an inlet valve 4, and an outlet valve 5. An exhaust gas system or the like may be connected to the outlet at which the outlet valve 5 is provided.

In FIG. 1, the piston 2 is under motion during a compression stroke of a two-stroke cycle, or during an intake stroke of a four-stroke cycle, and air, possibly together with fuel, will be flowing into the combustion chamber through the open inlet valve 4.

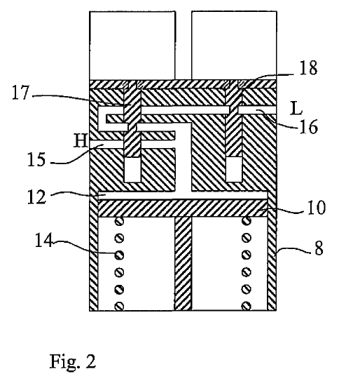

The combustion engine comprises a pneumatic actuator that forms a valve actuator 6 for the operation of the valves 4, 5. The valve actuator 6 is connected to, or comprises, a pressure fluid circuit 7 and comprises an actuator cylinder 8, 9 associated to a respective valve 4, 5, and an actuator piston 10, 11 provided in each actuator cylinder 8, 9. The circuit 7 may be open or closed. The high pressure on the high pressure side may be generated by a compressor. The actuator cylinder 8, 9 and the actuator piston 10, 11 associated thereto will, together with a cylinder head belonging to the actuator cylinder 8, 9, delimit an actuator chamber 12, 13. At the opposite side of the actuator piston 10, 11, in relation to the actuator chamber 12, 13, there is provided a spring means 14 (see FIG. 2) formed by a mechanical spring, in this case a helical spring. An expansion of the actuator chamber 12, 13 will result in a compression and, accordingly, a prestraining of the spring means 14.

As is most evident in FIG. 2, which only shows the valve actuator or part of valve actuator 6 that is associated to one of the valves 4, 5, the pressure fluid circuit 7 comprises a high pressure side H and a low pressure side L. Each actuator chamber 12, 13 is, via at least one first channel 15, connected with the high pressure side of the pressure fluid circuit 7 and, via a second channel 16, connected to the low pressure side of the pressure fluid circuit 7. There is provided at least one pilot valve 17, 18, which, preferably, is electromagnetically operated, and arranged so as to open and interrupt the communication in said first and second channels 15, 16 respectively. In the embodiment according to FIG. 2, a first pilot valve 17 is provided to open between the low pressure side L and the actuator chamber 12 or 13 while simultaneously closing between the high pressure side H and the actuator chamber 12 or 13, and vice versa, while a second pilot valve 18 is arranged so as to only open and interrupting the communication between the low pressure side L and the actuator chamber 12 or 13, wherein this later valve is the one of said valves 17, 18 that is located closest to the low pressure side in said second channel. If the second pilot valve 18 interrupts the communication in the second channel 16, the positioning of the first pilot valve in the position shown in FIG. 2 will not result in a communication between the low pressure side L and the actuator chamber 12, 13. FIG. 2 shows the pneumatic actuator 6 in a position in which the pilot valves 17, 18 open for a communication between the low pressure side L and the actuator chamber 12, 13. Thereby, the spring 14 will push or hold the actuator piston towards/in a first position, while the valve 4, 5 associated to the pneumatic actuator, accordingly, will be pushed towards or held in its closed position.

Provided that the engine valve 4, 5 is in its closed position and is to be opened, such a motion will be initiated by the pilot valve 17 being displaced from the position shown in FIG. 2, wherein the first pilot valve 17 is displaced to the position in which it opens for a communication between the high pressure side H and the actuator chamber 12, 13. Thereby, an elevated pressure, corresponding to the pressure of the high pressure side H, will be established in the actuator chamber 12, 13, and, provided that this pressure is of a sufficient magnitude in relation to the spring force of the spring 14, the actuator piston will be displaced towards a second position, corresponding to the lower dead end of the engine valve 4, 5. The absolute position of the second end position, that is the lift height of the engine valve, may be adapted with regard to the operational parameters of the engine, such as the engine speed, or a desired torque, and will be controlled through the determination of the timing of the interruption of the communication between the high pressure side H and the actuator chamber 12, 13. Thereby, the pilot valve 17 will be brought to the position in which it establishes a communication between the low pressure side L and the actuator chamber 12, 13.

Meanwhile, the second pilot valve 18 opens for the communication between the actuator chamber 12, 13 and the low pressure side L.

Subsequently, the energy stored in the spring 14 will contribute to stopping and, subsequently, displacing the actuator piston 10, 11 in a direction towards its first position. In order to prevent the engine valve 4, 5 driven by the valve actuator 6 from hitting its seat with a speed that is too high, and that might hurt the valve 4, 5 or the seat thereof, or result in a rebounce of the valve 4, 5, the motion of the actuation piston 10, 11 towards its first position, and the motion of the engine valve 4, 5 towards its closed position should be braked according to the invention. Here, this is achieved as the second pilot valve 18 is controlled so as to interrupt the communication between the low pressure side L and the actuator chamber 12, 13. Thereby, there will be a pressure increase in the actuator chamber 12, 13 during the continued motion of the actuator piston 10, 11 in a direction towards the first position. It is preferred that the braking is initiated early enough to result in a generation of a pressure in the actuator chamber 12, 13 of such a magnitude that, if no further measure is taken, the motion of the actuation piston 10, 11 would totally stop before the actuator piston reaches the first position. However, in reality, the actuator piston should not be allowed to stop before it reaches the first position, as will be further explained later.

Moreover, it is preferred to initiate the braking as late as possible, such that the motion of the actuator piston is not stopped until the actuator piston 10, 11 is very close to the first position.

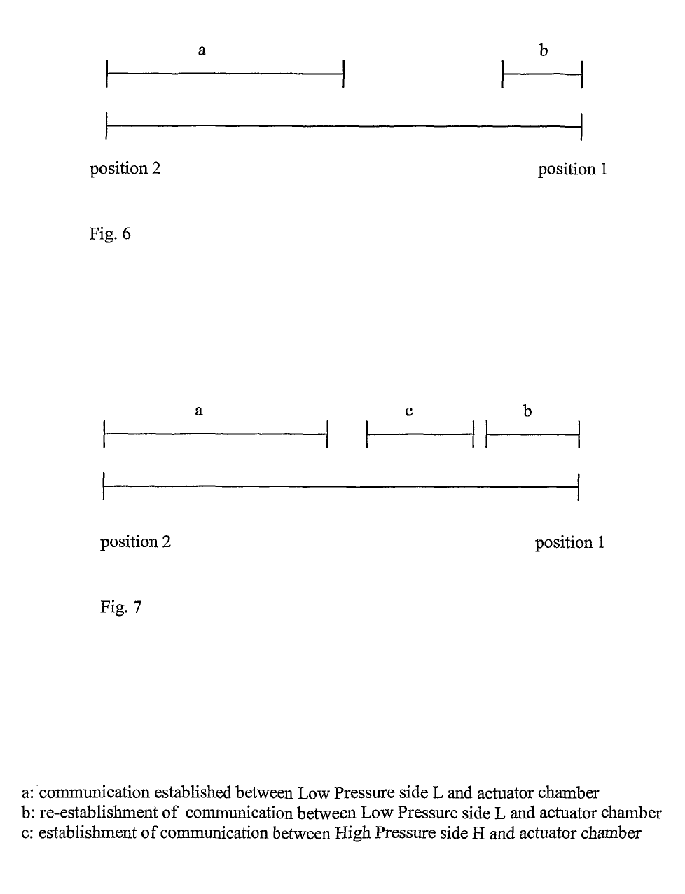

When, during the motion of the actuator piston 10, 11 towards its closed position, the speed thereof can be assumed to getting close to zero, the communication between the low pressure side L and the actuator chamber 12, 13 is reopened by a displacement of the second pilot valve 18 to its open position. Thereby, the pressure in the actuator chamber 12, 13 will decrease rapidly, and the energy remaining in the spring 14 will make the actuator piston continue its motion towards the first position. Provided that this step is performed sufficiently late during the returning motion of the actuator piston 10, 11 towards the first position, a soft landing of the engine valve 4, 5 in its seat will be achieved. Thereby, the described sequence of steps can be repeated. The steps that are taken during the motion of the actuator piston 10, 11 from its second position to its first position are also shown in FIG. 6.

A specific case that might occur is when the pressure in the actuator chamber 12, 13, during the braking of the actuator piston 10, 11, increases to such an extent that it will exceed the pressure existing at the high pressure side H. The valve actuator 6 may be provided with means thereby being arranged to open for a communication between the high pressure side H and the actuator chamber 12, 13. Such a means may comprise a non-return valve, provided in a channel which is a branch of or which is a parallel to the first channel 15 and which connects the high pressure side H to the actuator chamber 12, 13. This results in a certain degree of recycling of energy. In connection to the closure of any non-return valve, the communication between low pressure side L and the actuator chamber 12, 13 should be reestablished in order to provide for a soft landing of the engine valve 4, 5 in its seat. This sequence is represented in FIG. 7.

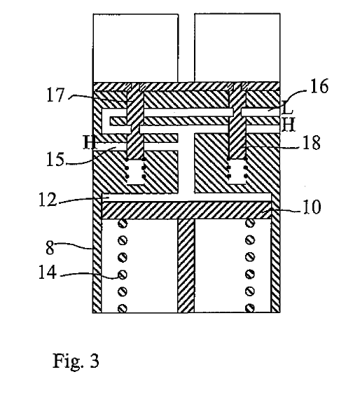

FIG. 3 shows an embodiment in which two first channels 15 connect the high pressure side H to the actuator chamber 12, 13, and in which each of two pilot valves 17, 18 is provided to open and interrupt the communication in each of the first channels 15. Moreover, each of the pilot valves 17, 18 is provided to interrupt and open the communication in the second channel 16, wherein the second pilot valve 18 is the one of said valves 17, 18 which is closest to the low pressure side. In FIG. 3, the actuator piston 10, 11 is in or near its first position. When the actuator piston 10, 11 is to be displaced to its second position, the first pilot valve 17 (or the second pilot valve 18, since it does not matter which one is displaced first) is displaced in order to open between the high pressure side H and the actuator chamber 12, 13. Thereby, it will interrupt the communication in the second channel 16 between the low pressure side L and the actuator chamber 12, 13. When, or before, the second position is reached, the first pilot valve is displaced back to the position which is shown in FIG. 3, i.e. to open the communication between the lower pressure side L and the actuator chamber 12, 13. Also the second pilot valve 18 will be displaced to a corresponding position, if it has not already been displaced to that position. In a preferred embodiment, the second pilot valve has remained in said position since the last time the actuator piston 10, 11 was in its first position. Thereafter, the actuator piston 10, 11 is once again displaced towards the first position during evacuation of air out of the actuator chamber 12, 13. When the actuator piston has been displaced a predetermined part of the distance between the second and the first positions, or when a predetermined period of time has lapsed, the second pilot valve 18 is displaced from the position shown in FIG. 3 towards the position in which it permits a communication between the high pressure side H and the actuator chamber 12, 13. Thereby, the braking effect may be more powerful than in the prior embodiment, since the high pressure side H is permitted to contribute to a rapid increase of pressure in the actuator chamber 12, 13. It might also happen that the increase of pressure in the actuator chamber during the short period of time that lapses between the moment when the second pilot valve interrupts the communication between the low pressure side L and the actuator chamber 12, 13 and opens the communication between the high pressure side H and the actuator chamber 12, 13 is sufficiently short in order to permit a pressure that is higher than the pressure of the high pressure side H to be generated in the actuator chamber. Thereby, as has also been described earlier, a pulse of pressurized air will flow from the actuator chamber in a direction toward the high pressure side, which is favourable from an energy-saving point of view.

When the speed of the actuator piston 10, 11 has decreased to a predetermined value, or when a predetermined period of time has lapsed, for example from the moment at which the second pilot valve 18 was displaced to its braking position, said pilot valve is once again brought to the position in which it permits a communication between the low pressure side L and the actuator chamber 12, 13. Thereby, the actuator piston 10, 11, under action from the spring 14, will be displaced the last remaining distance to the first position, which is the one shown in FIG. 3. It may be noted that the embodiment according to FIG. 3 shows the pilot valves as connected in series in relation to the low pressure side L and connected in parallel in relation to the high pressure side H. However, it is also possible with embodiments in which the pilot valves are connected in series in relation to the high pressure side and connected in parallel in relation to the low pressure side, or connected in parallel in relation to both the high pressure side and the low pressure side.

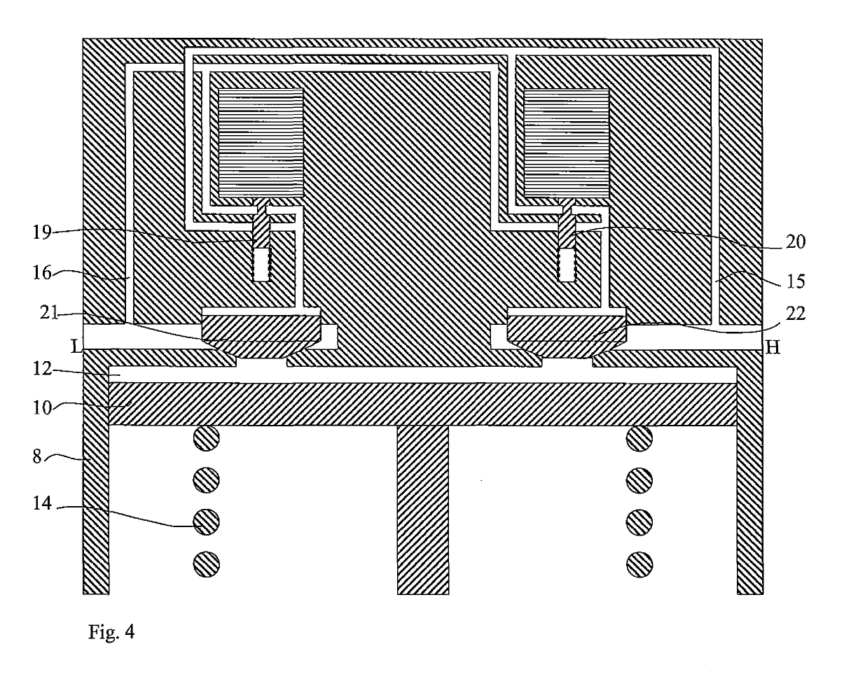

FIG. 4 shows an alternative design of the pneumatic actuator 6. This is a design that has already been described in earlier patent applications of the applicant, but that has been further developed by the control of the pilot valves that is suggested by the present patent application. Apart from two pilot valves 19, 20, the actuator 6 also comprises two slave valves 21, 22. Each of the slave valves 21, 22 is associated to a respective pilot valve 19, 20. A first slave valve 21 is provided in a space in which it is in direct communication with the low pressure side L on one side thereof, and in which it is in communication with either the low pressure side L or the high pressure side H on its other side, depending on the position of the first pilot valve 19 associated thereto. When the first pilot valve 19 opens for a communication between the low pressure side and said second side of the slave valve 21 associated thereto, the latter will permit a communication between the low pressure side L and the actuator chamber 12, 13. If the pilot valve permits a communication between the high pressure side and said second side, the slave valve 21 will not permit any communication between the actuator chamber 12, 13 and the low pressure side L.

The second slave valve 22 is provided in a space in which it is in direct communication with the high pressure side H on one side thereof, an in which it is in communication with either the low pressure side L or the high pressure side H on its other side, depending on the position of the pilot valve 20 associated thereto. When the second pilot valve 20 opens for a communication between the low pressure L and said second side of the slave valve 22 associated thereto, the latter will permit a communication between the high pressure side H and the actuator chamber 12, 13. In the opposite case, no communication between the high pressure side H and the actuator chamber 12, 13 is permitted, if not the pressure in the actuator chamber 12, 13 raises to such a degree that it exceeds the pressure on the high pressure side H to a certain degree. Through a suitable adaptation of the size of the surface of the slave valve which is turned towards the actuator chamber in relation to the size of said first side, it is, accordingly, possible to accomplish the function of a non-return valve of the slave valve in question. The design of the second slave valve 22 is adapted to the design of the first slave valve 21, such that the non-return valve function only exists at the second slave valve, that is the one that opens first.

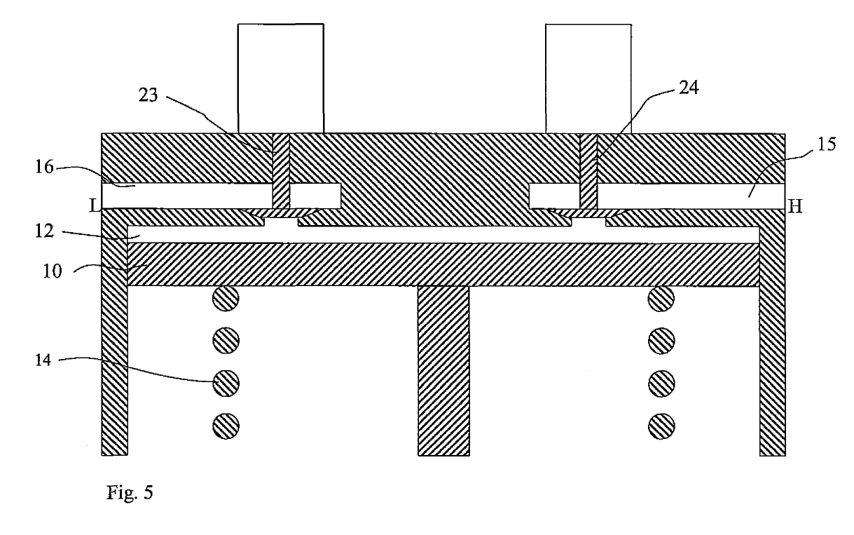

It is also possible to replace all pilot and slave valves with directly acting valves, if these directly acting valves have sufficient performance in order to be used in this context. FIG. 5 shows an example of such an embodiment, in which the valves 23, 24 are electrically, preferably electromagnetically, operated and provided so as to directly interrupt and open between the low pressure side L and the actuator chamber 12, 13, and between the high pressure side H and the actuator chamber 12, 13 respectively.

The pilot valves, slave valves and directly acting valves that has been disclosed above will form means for the establishment and interruption of the communication between the high pressure side H and the actuator chamber 12, 13, and the low pressure side L and the actuator chamber 12, 13. Moreover, said means comprises a control unit 25, preferably a computer program carrier comprising a computer program adapted for the control of the opening and closure of said pilot valves in accordance with such a sequence and upon such preconditions that will lead to the implementation of the method according to the present invention. The control of the pilot valves may be implemented by means of so called mapping, wherein the opening and closure of said valves is based on lapsed time, for example from the nearest preceding step. The alternative is a sensing of the position of the actuator piston or pistons in real time and a control upon basis thereof.

Finally, it should be mentioned that the combustion engine in accordance with FIG. 1 also comprises a member 26, for example a gas pedal, which is operatively connected to the control unit 25 for the purpose of giving a torque order. A sensor 27, opposite to a graded disc 29 provided on the engine shaft 28, is operatively connected to the control unit 25 and gives continuous information to the control unit 25 regarding the engine speed and the crank shaft position and/or the position of the piston 28 in the cylinder 1. The control unit 25, or more precisely the software or the like with which it is provided, will decide when the operable valves 4 and 5 are to open or close.

It should be realized that the invention has only been described by way of example, and that alternative embodiments will be obvious for a person skilled in the art. Therefore, it should be realized that the scope of protection of the invention is only delimited by what is defined in the patent claims, with support of the description and the annexed drawings.

I particular, it should be mentioned that the valves that has now been described as pilot valves might as well be formed by slave valves, that, in their turn, are controlled by other pilot valves. Furthermore, the two pilot valves 17, 18 that have been described above may be replaced by one single pilot valve if permitted by the individual application. For example, the second pilot valve 18 in FIG. 2 and 3 could be excluded, whereby, however, a more rapid function of the remaining single pilot valve 17 will be required for their corresponding operational conditions and operations, since the latter valve must then be displaced twice, in order to open the engine valve and in order to brake the engine valve, during the same period of time as each one of the two described valves only required one individual displacement.

1. A method of braking an actuator piston (10, 11) of a pneumatic actuator (6) connected to a pressure fluid circuit (6) that comprises a high pressure side (H) and a low pressure side (L), and that comprises
a) an actuator cylinder (8, 9);
b) an actuator piston (10, 11) provided in said actuator cylinder (8, 9) and displaceable between a first position and a second position;
c) an actuator chamber (12, 13), delimited by said actuator cylinder (8, 9) and said actuator piston (10, 11), wherein the volume of said actuator chamber decreases upon a displacement of the actuator piston (10, 11) from the second to the first position; and
d) and a spring means (14) provided so as to drive the actuator piston (10, 11) from the second position to the first position, wherein, during a displacement of the actuator piston (10, 11) from the second position towards the first position, there is established or maintained a communication between the low pressure side (L) and the actuator chamber (12, 13), while, at the same time, the communication between the high pressure side (H) and the actuator chamber (12, 13) is kept interrupted, said method being characterized in that, before the actuator piston (10, 11) reaches the first position, said communication between the low pressure side (L) and the actuator chamber (12, 13) is interrupted.

2. A method according to claim 1, characterized in that the communication between the low pressure side (L) and the actuator chamber (12, 13) is interrupted when a continued reduction of the volume of the actuator chamber (12, 13) up to the point when the actuator piston (10, 11) reaches the first position is of such a magnitude that the increase of pressure that is generated in the actuator chamber (12, 13) during the continued motion of the piston is sufficient for substantially reducing the speed of the actuator piston (10, 11) before the actuator piston (10, 11) reaches the first position.

3. A method according to claim 1, characterized in that the communication between the low pressure side (L) and the actuator chamber (12, 13) is interrupted when a continued reduction of the volume of the actuator chamber (12, 13) up to the point when the actuator piston (10, 11) reached the first position, is of such a magnitude that the increase of pressure that is generated in the actuator chamber (12, 13) during the continued motion of the piston is sufficient for reducing the speed of the actuator piston to zero before the actuator piston (10, 11) reaches the first position.

4. A method according to claim 1, characterized in that the communication between the low pressure side (L) and the actuator chamber (12, 13) is interrupted after half of the travelling distance of the actuator piston (10, 11) between the second and the first positions, preferably after a third of said travelling distance, and even more preferably, after a quarter of said travelling distance.

5. A method according to claim 1, characterized in that, subsequently to the communication between the low pressure side (L) and the actuator chamber (12, 13) having been broken, there is established a communication between the high pressure side (H) and the actuator chamber (12, 13) if the pressure in the actuator chamber (12, 13) goes above the pressure on the high pressure side (H).

6. A method according to, characterized in that the communication between the low pressure side (L) and the actuator chamber (12, 13) is re-established when the motion of the actuator piston (10, 11) ceases or nearly ceases before the actuator piston (10, 11) reaches the first position.

7. A method according to claim 6, characterized in that the communication between the low pressure side (L) and the actuator chamber (12, 13) is re-established generally at the moment at which the motion of the actuator piston (10, 11) towards the first position stops.

8. A method according to claim 7, characterized in that the communication between the high pressure side (H) and the actuator chamber (12, 13) is interrupted in connection with the re-establishment of the communication between the low pressure side (L) and the actuator chamber (12, 13).

9. A pneumatic actuator, connected to a pressure fluid circuit (6) that has a high pressure side (H) and a low pressure side (L), and comprising
a) an actuator cylinder (8, 9);
b) an actuator piston (10, 11) provided in said actuator cylinder (8, 9) and displaceable between a first position and a second position;
c) an actuator chamber (12, 13), delimited by said actuator cylinder (8, 9) and the actuator piston (10, 11), wherein the volume of said actuator chamber decreases upon a displacement of the actuator piston (10, 11) from the second to the first position; and
d) a spring means (14) provided to drive the actuator piston (10, 11) from the second position to the first position, and means (18, 25) provided to maintain or establish a communication between the low pressure side (L) and the actuator chamber (12, 13), during a displacement of the actuator piston (10, 11) from the second position towards the first position, and at the same time to keep the communication between the high pressure side (H) and the actuator chamber (12, 13) interrupted, and wherein the pneumatic actuator is characterized in that is comprises means (18, 25) provided to interrupt said communication between the low pressure side (L) and the actuator chamber (12, 13) before the actuator piston (10, 11) reaches the first position.

10. A pneumatic actuator according to claim 9, characterized in that it comprises means (18, 25) arranged so as to interrupt the communication between the low pressure side (L) and the actuator chamber (12, 13) when the actuator piston (10, 11) has reached a predetermined position while moving from the second position to the first position.

11. A pneumatic actuator according to claim 9, characterized in that it comprises means (18, 25) arranged so as to re-establish the communication between the low pressure side (L) and the actuator chamber (12, 13) upon pre-determined conditions.

12. A pneumatic actuator according to claim 9, characterized in that it comprises means (17, 25) arranged to establish a communication between the high pressure side (H) and the actuator chamber (12, 13) in connection with the interruption of the communication between the low pressure side (L) and the actuator chamber (12, 13) and if the pressure in the actuator chamber (12, 13) goes above the pressure on the high pressure side (H).

13. A pneumatic actuator according to claim 9, characterized in that a comprises a sensor for sensing the motion and position of the actuator piston (10, 11) in the actuator cylinder (8, 9), and means (17, 25; 18, 25) that, based upon a signal from said sensor, are arranged so as to control the establishment and the interruption of the communication between the high pressure side (H) and the actuator chamber (12, 13), and between the low pressure side (L) and the actuator chamber (12, 13) respectively.

14. A pneumatic actuator according to claim 9, characterized in that comprises a sensor for sensing any noise or vibration that is generated when the engine valve goes into its valve seat, and means (17, 25; 18, 25) that, upon basis of a signal from said sensor, are arranged so as to control the establishment and the interruption respectively of the communication between the high pressure side (H) and the actuator chamber (12, 13), and between the low pressure side (L) and the actuator chamber (12, 13).

15. A pneumatic actuator according to claim 9, characterized in that it comprises at least one electrically, preferably electromagnetically, operated valve member (17, 18; 19, 20), arranged so as to control the establishment and the interruption respectively of the communication between the high pressure side (H) and the actuator chamber (12, 13), and between the low pressure side (L) and the actuator chamber (12, 13) respectively.

16. A combustion engine, comprising at least one cylinder (1) and a piston (2) that moves reciprocatingly in said cylinder, and a combustion chamber (3) delimited by the cylinder (1) and the piston (2), and at least one inlet for the introduction of combustion air into the combustion chamber (3), and at least one outlet for the discharge of exhaust gases from the combustion chamber (3), wherein at least one of said inlet and outlet is provided with at least one freely operable, valve (4, 5) driven by means of pressure fluid, and characterized in that it comprises a pneumatic actuator (6) according to any one of claims 9-15 for the operation of said at least one valve (4, 5).
